(19) United States
(12) Patent Application Publication
(10) Pub. No.: US 2007/0017400 A1
(43) Pub. Date: Jan. 25, 2007

(54) Magnetic color printer/copier

(76) Inventors: Toshihiro Fukumoto, TOKYO (JP); Keiko Ebato, Tokyo (JP)

Correspondence Address: BROWDY AND NEIMARK, P.L.L.C.;624 NINTH STREET, NW, SUITE 300, WASHINGTON, DC, 20001-5303, US

(21) Appl. No.: 10/545,164

(22) PCT Filed: Feb. 10, 2004
(86) PCT No.: PCT/JP04/01377

§ 371 Date: Sep. 15, 2006

(51) Int. Cl. B41M 1/42

(52) U.S. Cl. 101/489

(57) ABSTRACT

In a magnetic printer, magnetic needles (5) are arranged in a row on the outer periphery of a holding plate (4, 15) to form a magnetic head producing a magnetic pattern corresponding to magnetic information. Further, in the printer, an ultrafine pigment magnetic powder-jetting pipe (3), a heating pipe (22), a cooling pipe (23), and a temperature measurer (24) are arranged close to one another at positions opposed to the magnetic head. An object on which printing is to be performed is passed between the magnetic head and each of the pipes and temperature measurer, so that the ultrafine pigment magnetic powder is fixed on the object at positions corresponding to the magnetic information. The ultrafine pigment magnetic powder-jetting pipe (3) is connected to a pigment-preparing device (8) for preparing the ultrafine pigment magnetic powder. The pigment-preparing device (8) is constituted of tanks (7) for separately storing a thermoplastic agent, a magnetic body, and pigment, and of a pigment-compounding chamber (14) for compounding the different powder materials in the tanks (7).

### TECHNICAL FIELD

So far the copier or the printer except for business use was mainly the monochrome copier that uses the carbon whose reaction for static electricity as the toner is the best, an ink-type or the bubble jet type full-color printer, printed with the dye liquid (the dye liquid was sprayed on paper by a minute bubble), or the sublimation print with ribbon that puts sublimation type color dye. So the toner was not able to be used, and it was necessary to use a liquid, melted dye at the full-color type copier or the printer. Therefore, there were problems of high cost, and the blot of dye in back of paper, which were the maximum concern of the industry to solve. The present invention is a technology that solves this problem, and achieves the copy and the print of full-color by the toner method, which is familiar to the public. A full-color copy and the print by the toner method solve the past problems of the past liquid dye, for example, discoloration by sunlight, the blot with water at dry time. The ordinary user can receive these benefits and enjoy the copy and the print of full-color cheaply, easily. The present invention fundamentally prevents the past problem.

### BACKGROUND ART

Until now, the print and the copy using the liquid, melted type ink were main currents. By improving a technological level to the control of the liquid, melted type ink, the concern of the industry was suitable for a more beautiful photograph and a faster speed compared with the cost performance. The ordinary user, however, was interested in a cheap, beautiful photograph and copy. After the Xerox Co. had invented an electrostatic copier, the copy of black and white evolved from an analog method to a digital one, but the method of putting the carbon on paper by static electricity is still a main current. On the other hand, the inkjet method of the bubble method is a main current in the print except for business use, and the industry is competing how fine the bubble, number of pixels become to the signpost of the level of the technology.

### THE PROBLEMS TO BE SOLVED BY THE INVENTION

In the full-color and print compound machine, the use of the solid color dye of the toner type with an easy handling is enabled. Therefore, the toner is put on paper by using magnetism, and it is heated and welded onto the paper by using organic plastic. The blot and discoloration are lost by this technology, and the color ink that is the articles of consumption is made cheap, and an excellent compound type of full-color printer in the cost performance is achieved by mass-producing the toner.

A multiple print was assumed to be a field of an expensive printer such as offset duplicators, that required the many experiences, or multi-step continuous printers. The present invention, however, uses the plasticizer with the difference of the heat temperature. It is a structure that is used for a cheap printer and the copy compound machine. It is possible to use it also for the domestic use.

By using the plasticizer with different heat temperature, it comes to be able to control the color reproducibility to printed matter easily and at low price.

Using a supersonic wave motor and a linear motor, etc. improves the silence of the compound type printer, and the object such as paper feeder and the sensor of reading paper can be accurately controlled.

The single printing machine can similarly achieve the control of the color and paper feeder accurately and cheaply.

### MEANS FOR SOLVING PROBLEMS

A personal computer, a digital camera, a domestic copy etc. are managed by combining electronic signal (1, 0) and the number of combinations is different by the usage. Therefore it can be facilitated to change the information to the strength of the magnetism. Firstly, magnetic body joined to drum, flat plate, or bending plate in side position of the each dot set up as the electromagnet. The digital signal of each dot read by a photosensitive chip such as CCD is changed to magnetic information and transmitted strength to the magnetic board, drum etc., or directly transmitted to the printed paper and make the ultrafine pigment powder absorb to it. The ultrafine pigment powder is accommodated by the tank according to each color. The tank is set up in the accommodation space of the printer according to the design purpose such as multiple-step, the ultrafine pigment powder corresponding to color information on each dot transmitted by the controller is discharged by opening and shutting of the nozzle, pressurizing, and pressurizing with the gas such as a physical machine. Then, the ultrafine pigment powder is mixed.

The ultrafine pigment powder is composed of fine iron powders, organic and inorganic coloring matter corresponding to three primary colors, those that exist in its each complementary relation, black coloring matter and the heat-melting organic plasticizer. Iron powder, coloring matter and heat-melting organic plasticizer are processed to the ultrafine pigment powder in the grainy and massiveness and accommodated to each tank stably at the mixing rate the same as the design.

At a multiple print, the thermoplastics that melts at a reasonable heat temperature is put from the mixing coloring matter which has high heat melt temperature, gradually, ultrafine pigment powder which has the mixing coloring matter which has low heat melt temperature put by the temperature management.

Heating process is done by the heating pipe with the super-small caliber that can raise temperature instantaneously up and cooling pipe that lowers the temperature to the preset temperature. The ultrafine pigment powder corresponding to the temperature is put and melted from the place whose temperature is high by each dot of one row in each side.

The ultrafine pigment powder changes the color reproduction of the print. It is based on combining the light and shade of color by the character as its difference of minute mass of the iron content and the difference of the melt temperature of the thermoplastics.

In addition to using the difference of the melt temperature of the thermoplastics, using the control of amount of mixing of the coloring powder depending on the difference of magnetic reaction because of the amount of mixing of the iron fine powder that includes organic iron compound and inorganic iron compound contribute to cost reduction on account of the decrease of the multiple print frequency.

In general, the operation is done by combining spindle-motor and the gear with a high cost and reliability. If mass production can make the cost reduction, the expression of the print is ameliorable because of the precise control by a supersonic wave motor and a linear motor. In that case, magnetism control of electric magnet, opening and closing of the tank nozzle of ultrafine pigment powder and the paper feeder are controlled at the same time.

A horizontal number of dots is decided depending on the number of a magnetic body. The illustration by the personal computer, the number of pixels by the pixel structure of the digital camera, the image or the document, etc. taken by the scanner are very variegated. It is not necessary for the magnetic body and the electric magnet generation body that makes a digital signal magnetic to stick. It only has to be connected with the wire. Therefore, the set place of the electric magnetic generation body is based on the designer's free conception, and freewheeling thinking such as the design valuing, the performance valuing and the cost valuing of the printer becomes possible.

The number of dots of vertical directions is decided by making a magnetic body minutely and improving the control accuracy of the paper feed mechanism. Therefore the motor with high supersonic wave that control of a minute rotational speed is needed. In addition, the temperature of paper is managed precisely by using the temperature sensor.

### TECHNICAL ADVANTAGE OF THE INVENTION

The present invention disclose the printer and the copier of the toner method using magnetism, not the bubble jet method whose sublime ink adheres to the ribbon with water solubility coloring matter.

It has the print performance equal to an offset method printer, its features are the few discoloration, blot the color and back of paper.

This printer uses magnetism, so the free design and producing the different shape compared with ordinary one are possible.

This printer has the precise print control because of using the digital signal of the difference of magnetism and temperature at the same time. This is because this printer uses ultrafine pigment powder with iron powder and thermoplastics.

This printer uses the change of the flow of air and the atmospheric pressure by controlling a high-pressure gas and the pressure reducing device, and mixes the coloring powder in the mixing room by the digital signal, and the coloring powder is put on paper by digital signal.

### BEST MODE TO PUT AN INVENTION INTO PRACTICE

### Embodiment

FIG. 1 shows the related chart of the relation among the magnetism body, paper feeder, ultrafine pigment powder squirt, and heating or cooling pipe of the heat welding plasticizer.

FIG. 2 shows an above figure of pigment mixture device where it accommodates the pigment tank by an independent type.

FIG. 3 shows a transverse sectional view of the pigment mixture device. Ultrafine pigment powder falls into the mixing room where is decompressed by the pressure reducing tank (showed by (12)), and adheres to paper or transcript board pulled by the magnetism of each dot. Next, pressure gas is gushed from the pressurized tank (showed by (9)) to remove completely the pigment powder that remains a little. Repeating this process, it is prevented that the remaining pigment contaminated.

FIG. 4 shows a related chart of the magnetic body and the electric magnetic generation device. The board that makes the pigment absorbed fixes a magnetic body, and absorbs the pigment to the position of the provided dot. The magnetic generation device is the covered wire with a good magnetic condition, and transmits the strength of magnetism to the magnetic body set up individually.

FIG. 5 shows the paper running power device for paper feed. The bonding area with paper is wide since minute operation management is done, and the advantage of the interior type is more abundant because of lightening and making to compact.

### INDUSTRIAL APPLICABILITY

The present invention is able to print with high chroma at a low price and reduce the running cost.

### BRIEF DESCRIPTION OF THE DRAWINGS

FIG. 1 It is a concept chart to have shown the relation of the per device.

FIG. 2 It is a concept chart of the upper surface of the pigment mixture device.

FIG. 3 It is a concept chart of the horizontal side of the pigment mixture device.

FIG. 4 It is a concept chart to have shown the relation between a magnetic body and the electric magnetic generation device.

FIG. 5 It is a concept chart of the paper running power device.

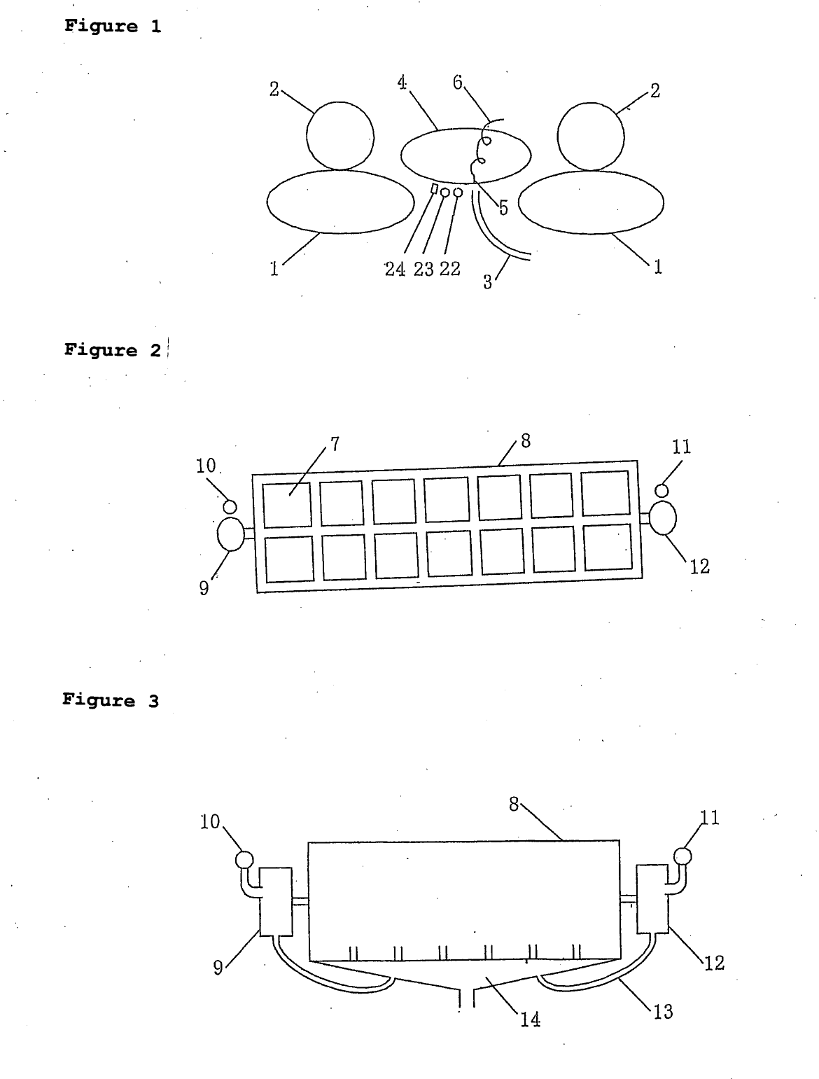

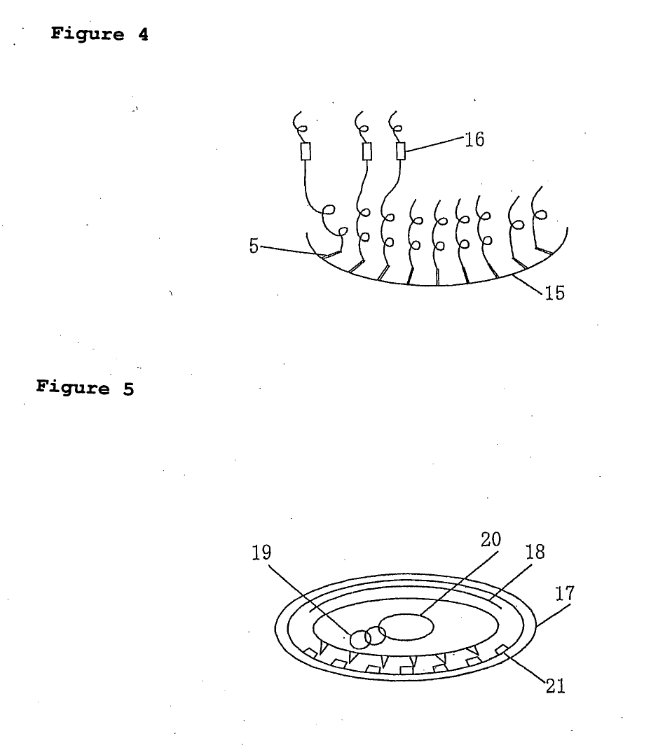

### EXPLANATIONS OF LETTERS OR NUMERALS

1 Paper feed device
2 Pressure roller
3 Ultrafine pigment powder gush pipe
4 Pigment absorption board
5 Magnetic body
6 Magnetic conduction wire
7 Pigment storage tank
8 Pigment mixture device
9 Pressurizing gas tank
10 Pressurizing pump
11 Decompression pump
12 Decompression tank
13 Pipe
14 Pigment mixing room
15 Magnetic body maintenance board
16 Electromagnet that converts a digital signal into magnetism
17 Toroidal rubber for paper feed
18 Board for putting on pressure as for paper
19 Gear device for paper feed
20 Small motor
21 Toroidal rubber operation toroidal gear or projection
22 Heating pipe
23 Cooling pipe
24 Temperature sensor

1. Structure that makes coloring powder with minute iron powder and organic thermoplastics welding at a low temperature respectively, converts electric signal of each dot sensed by the personal computer to magnetic signal, adheres and prints ultrafine pigment powder to metallic drum.

2. Structure that the drum above mentioned is made of the material with the device which can delete the magnetic signal at once, the magnetic signal is corresponding to the magnetic change which strength shows several steps, the drum has the device that colors ultrafine pigment powder to the drum, and the structure that reacts sensitively with each signal, adheres the ultrafine pigment powder according to the computer signal and represents the color change.

3. Structure that puts the paper etc. with ultrafine pigment powder to the heated pipe with organic thermoplastics without mixture the ultrafine pigment powder in order to stabilizes.

4. Structure that combines ultrafine pigment magnetic powders of cyanogens (blue green), magentas (red purple), yellow and black compound, discharges ultrafine pigment powder by computer-controlled, and puts the powder to the colored drum by the magnetic power.

5. Structure that operates the squirt not only the control of slight nozzle operation of each coloring matter tank by computer-controlled but the assist by dry air pressure controlled with computer in the case that each ultrafine pigment powder can not be gush by the only magnetic power as it is setting.

6. Structure of the precise controller of the printed matter and photograph by the supersonic wave motor or the linear motor, which can be operated by usual power supply.

7. Structure to make tank multistage, which accommodates ultrafine pigment powder to improve work and accuracy, and to change the amount of absorption in which mass of iron content contained in powder at the same time as providing each division.

8. Structure to enable multiple print and accommodate the ultrafine pigment powder that is mixed with the welded plasticizer which puts organic thermoplastics which reacts from the high temperature degree to low temperature degree in the multiple stage type coloring matter tank in the case that operates multi-step putting by the multistage tank.

9. Structure that decompresses the mixing room to mix each minute coloring matter powder as the rule, which become the help for falling ultrafine pigment powder by the coloring matter tank as the control of the weight or exhausting by magnetism, gushes the coloring matter powder to the magnetic body of each dot from the nozzle, makes the decompression tank suck the coloring matter powder by injecting dry high pressure air or gas to prevent the coloring matter powder that remains in mixing room from mixing.

10. Structure to make the paper feed stably by setting the paper running device which is a flat oval structure for making the paper feed smoothly as much as possible and for stabilizing the paper.

11. Structure of placing temperature sensor behind cooling pipe in order to control stiffening temperature and to achieve best temperature for multiple printing.
